(19) United States
(12) Patent Application Publication
(10) Pub. No.: US 2001/0035335 A1
(43) Pub. Date: Nov. 1, 2001

(54) Switch subassembly and component assemblies including such a switch subassembly

(76) Inventor: Nigel Victor Spurr, Hall Green (GB)

Correspondence Address: Anthony P. Cho, CARLSON, GASKEY & OLDS, P.C., Suite 350, 400 West Maple Road, Birmingham, MI, 48009, US

(21) Appl. No.: 09/841,263

(22) Filed: Apr. 24, 2001

(30) Foreign Application Priority Data
Apr. 26, 2000 (GB) GB0010045.3

(51) Int. Cl. H01R 13/70

(52) U.S. Cl. 200/51 R

(57) ABSTRACT

A switch subassembly (10) having a switch mount (16), the switch subassembly further including at least one switch contact (50) for providing a switch function and switch terminals (48, 50) for electrically connecting the switch to an electric circuit (74), in which the at least one switch contact and the switch terminals are provided on the switch mount such that when the switch mount is abutted again a further component (12), the further component and switch mount defining a volume (28) such that the at least one switch contact and the switch terminals are enclosed in the volume and the switch terminals are connected in use to electrical terminals of an electric circuit (FIG. 2).

This application claims priority to British application number GB0010045.3 filed on Apr. 26, 2000.

### BACKGROUND OF THE INVENTION

The present invention relates to switch subassemblies and to component assemblies including such switch subassemblies. In particular, the component assembly may be a door latch for a vehicle.

Known vehicles, such as cars, include doors having door latches enabling the door to be opened and closed. The door latches further include features enabling the latch to provide for a locked, unlocked, superlocked, or child safety condition. Such conditions can be provided for by appropriate electric motors. Furthermore, known doors include powered closing features and powered release features, again provided for by electric motors.

Microswitches are provided which operate to indicate various positions of components of the door latch. Such microswitches are provided to the door latch manufacturer as sealed units having a switch button or switch lever actuatable by being contacted by moving components of the latch assembly to provide switching on and off. The switch further includes exposed switch terminals for connection to electric circuit terminals when the switch is assembled into the latch. Once the switch has been assembled into the latch and the switch terminals and electric circuit terminals connected, typically by solder or crimping methods, the exposed terminals have to be “potted” in a water resistant material to ensure that corrosion of the terminals does not subsequently take place.

Thus two separate sealing operations take place, one when the switch per se is assembled, for example two halves of the switch casing have to be sealed against each other, and a second sealing operation takes place to seal the terminals once they have been connected to the electric circuit of the latch.

It is an object of the present invention to provide an improved form of switch subassembly that is easier and cheaper to produce.

### SUMMARY OF THE INVENTION

According to the present invention there is provided a switch subassembly having a switch mount. The switch subassembly further includes at least one switch contact for providing a switch function and switch terminals for electrically connecting the switch subassembly to an electric circuit. The at least one switch contact and the switch terminals are provided on the switch mount. The switch mount is abutted against a further component. The further component and switch mount define a volume such that the at least one switch contact and the switch terminals are enclosed in the volume. The switch terminals are connected, in use, to electric circuit terminals of an electric circuit.

According to a further aspect of the present invention the component assembly comprises a switch subassembly and a further component. The switch subassembly includes a switch mount, at least one switch contact for providing a switch function and switch terminals for electrically connecting the switch subassembly to an electric circuit. The at least one switch contact and the switch terminals are provided on the switch mount. When the switch mount is abutted against the further component, the further component and the switch mount define a volume such that the at least one switch contact and the switch terminals are enclosed in the volume. The switch terminals are connected to electric circuit terminals of the electric circuit.

According to a further aspect of the present invention, the component assembly comprises a switch subassembly and a further component. The switch subassembly includes a switch mount, a switch contact for providing a switching function and switch terminals for electrically connecting the switch subassembly to an electric circuit of the further component. The at least one switch contact is provided on the switch mount such that when the switch mount is abutted against the further component, the further component and the switch mount define a volume. The at least one switch contact is enclosed in the volume. The further component and the switch assembly are capable of electrically cooperating.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is an isometric view of a switch subassembly according to the present invention.

FIG. 2 is a cross section plan view of FIG. 1 additionally showing electric circuit terminals 42 and 44 of a further component.

FIG. 3 is a cross-section side elevation view of FIG. 1.

FIG. 4 is a cross-side elevation view of FIG. 2 wherein the switch subassembly is mounted on a further component to provide for a component assembly according to the present invention.

### DETAILED DESCRIPTION OF THE PREFERRED EMBODIMENT

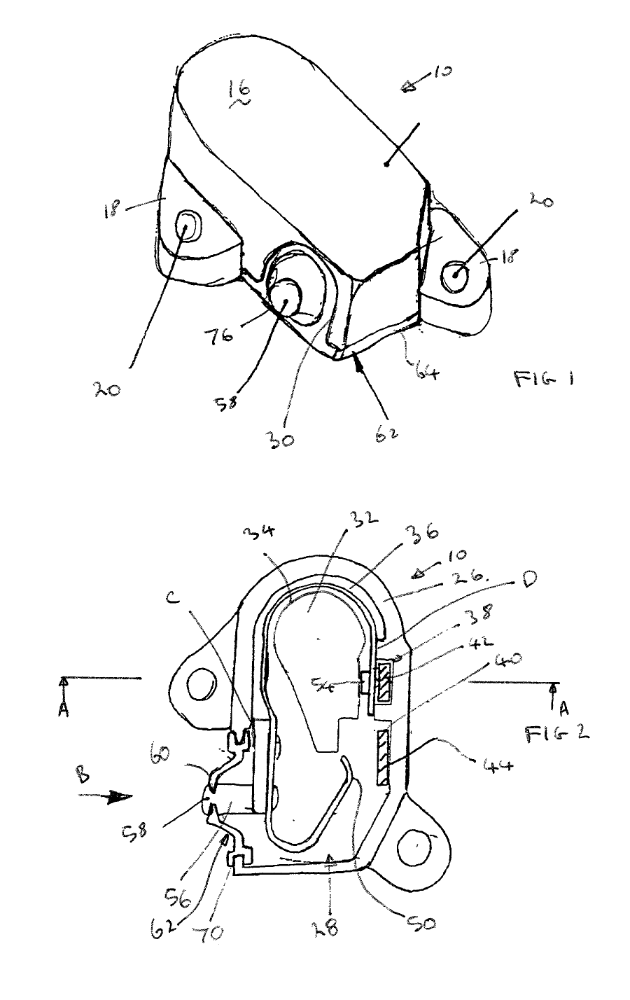

With reference to FIGS. 1, 2 and 3 there is shown a switch subassembly 10 according to the present invention. With reference to FIG. 4 there is shown the switch subassembly 10 mounted on a further component 12 (only part of which is shown) to provide for a component assembly 14 according to a further aspect of the present invention.

As seen in FIG. 1, switch subassembly 10 includes a switch mount in the form of housing 16 having mounting lugs 18 with mounting holes 20 that allow the switch subassembly 10 to be secured to the further component 12 via fixing means (not shown) such as bolts. In further embodiments alternative fixing means could be used and in particular snap fit arrangements could be used.

As seen in FIGS. 2, 3, and 4, housing 16 includes a body portion 22 having a planar portion 24 and wall 26 which together define a recess 28. Wall 26 is interrupted by an open sided slot 30.

As illustrated in FIGS. 2 and 4, situated within recess 28 is a boss 32 having a curved portion 34 spaced from an adjacent portion of wall 26 to provide channel 36.

Recess 28 further includes spaces 38 and 40 within which electric circuit terminals 42 and 44 sit. Positioned within recess 28 is a resilient metal strip 46 having switch terminal 48 and switch contact 50. Switch terminal 48 is positioned at one end of the resilient metal strip and includes a raised contact portion 52 for engagement with electric circuit terminal 42 and bent tab 54 which abuts boss 32 and acts to resiliently bias the raised contact portion 52 against electric circuit terminal 42.

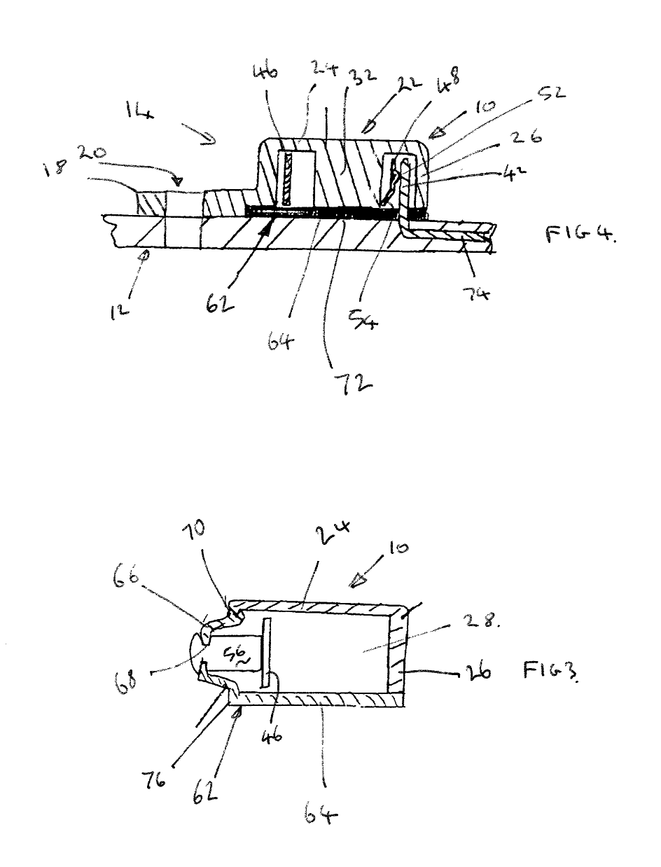

Switch contact 50 is situated at the other end of the resilient metal strip and is in the form of a curved portion for engagement with and disengagement from electric circuit terminal 44. Secured part way along the resilient metal strip is actuatable element 56 having head 58 which projects beyond wall 26 of housing 16 as seen in FIG. 2 and 3. Head 58 includes an annular groove 60.

In FIG. 3, resilient sealing element 62 includes a substantially planar portion 64 with an actuatable element sealing portion 66 depending therefrom. The actuatable element sealing portion including a hole 68, the edges of which engage groove 60 of head 58 as seen in FIG. 2. The actuatable element sealing portion also includes a bifurcated edge 70 which receives the edge of open sided slot 30.

It can be seen from FIG. 4 that with the switch assembled onto the further component 12, the substantially planar portion 64 of the resilient sealing element 62 lies substantially between the body portion 22 of the switch subassembly 10 and a surface 72 of the further component 12. In this case the further component 12 includes an electric circuit 74 molded therein that terminates at electric circuit terminals 42 and 44. The resilient metal strip is retained in the housing prior to assembly of the switch subassembly on to the further component by virtue of the resilient nature of the metal strip and contact at points C and D with the housing as shown in FIG. 2.

It can be seen further in FIG. 2 that the resilient sealing element 62 substantially seals the switch subassembly prior to final assembly onto the further component (though in further embodiments this need not be the case). In particular, at this pre-assembled stage, no holes are present in the resilient sealing element 62 to accept electric circuit terminals 42 and 44. Upon final assembly the electric circuit terminals 42 and 44 puncture the resilient element 62 and enter spaces 38 and 40 of the recess 28.

When fully assembled, movement of the head 58 in the direction of arrow B of FIG. 2 causes switch contact 50 to engage electric circuit terminal 44 thereby completing the electric circuit. It can be seen that switch contact 50 also acts as a switch terminal under these circumstances. In further embodiments the function of providing a switch contact of the switch can be separated from the function of providing a switch terminal.

In this case the substantially planar portion 64, which seals the switch subassembly to the first component, and the actuatable sealing portion 66, which seals the actuatable element to the switch body, are unitary, though in further embodiments this need not be the case. In particular a separate hole could be provided for the actuatable element with an independent seal.

As seen in FIG. 2 and 3, furthermore in this case it should be noted that edge 76 of the resilient sealing element 62 bridges the open end of open sided slot 30 and thus provides for sealing of the actuatable element 56 against the further component 12 in this region.

In this case the further component 12 is a door latch and surface 72 is provided by a housing of the door latch. In further embodiments different further components could be used such as actuators or electric motors and surfaces equivalent to surface 72 could be provided by housing of such actuators or motors.

Furthermore in further embodiments a resilient sealing element could be provided which is substantially elongate and is positioned around that edge of the housing that abuts the further component. Such an arrangement could only provide for sealing when the subassembly is abutted against the further component.

The term sealing is used herein to encompass differing degrees of the sealing. For example the term can encompasses seals that are waterproof, or water resistant, or dust proof, or dust resistant. Depending upon the particular installation requirement such exemplary degrees of sealing may be required or alternatively greater or lesser degrees of sealing may be required.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A switch subassembly having a switch mount, the switch subassembly further including at least one switch contact for providing a switch function and switch terminals for electrically connecting the switch subassembly to an electric circuit, in which the at least one switch contact and the switch terminals are provided on the switch mount such that when the switch mount is abutted against a further component, the further component and switch mount define a volume such that the at least one switch contact and the switch terminals are enclosed in the volume and the switch terminals are connected, in use, to electric circuit terminals of an electric circuit.

2. A switch subassembly as defined in claim 1 in which the switch mount is in the form of a housing which at least partially contains the at least one switch contact and the switch terminals.

3. A switch subassembly as defined in claim 2 in which the housing substantially contains the at least one switch contact and the switch terminals.

4. A switch subassembly as defined in claim 3 in which the housing fully contains the at least one switch contact and the switch terminals.

5. A switch subassembly as defined in claim 2 in which the housing includes space for electric circuit terminals of an electric circuit.

6. A switch subassembly as defined in claim 1, including an actuatable element operable to provide for the switch function, the actuatable element being provided in an aperture of the switch mount.

7. A switch subassembly as defined in claim 6 in which the actuatable element projects from the aperture.

8. A switch subassembly as defined in claim 6 in which the actuatable element is sealed relative to proximal portions of the aperture.

9. A switch subassembly as defined in claim 6 in which a first resilient sealing element provides a seal between the actuatable element and proximal portions of the aperture.

10. A switch subassembly as defined in claim 6 in which the aperture is in the form of a hole.

11. A switch subassembly as defined in claim 6 in which the aperture is in the form of an open sided slot.

12. A switch subassembly as defined in claim 1 including a second resilient sealing element operable to seal the volume, in use, by co-operation with the further component.

13. A switch subassembly as defined in claim 12 in which the second resilient sealing element is substantially planar and acts to substantially seal the switch mount in the absence of the further component.

14. A switch subassembly as defined in claim 13 in which the second resilient sealing element is punctured, in use, by electric circuit terminals during assembly of the switch subassembly onto the further component.

15. A switch subassembly as defined in claim 12 in which the second resilient sealing element is substantially elongate and acts substantially at an edge of the switch mount to seal the volume, in use, only in the present of the further component.

16. A switch subassembly as defined in claim 12 wherein the first and second resilient sealing elements are in the form of a unitary seal.

17. A switch subassembly as defined in claim 16 in which the unitary seal includes a portion that seals, in use, between the actuatable element and the further component.

18. A switch subassembly as defined in claim 1 in which the first switch contact acts as one of the switch terminals.

19. A switch subassembly as defined in claim 1 in which the at least one switch contact is resiliently mounted on the switch mount.

20. A switch subassembly as defined in claim 1 in which one or more of the switch terminals is resiliently mounted on the switch mount.

21. A switch subassembly as defined in claim 1 suitable for connection to a door latch or an actuator.

22. A component assembly comprising a switch subassembly and a further component, the switch subassembly including a switch mount, at least one switch contact for providing a switch function and switch terminals for electrically connecting the switch subassembly to an electric circuit, in which the at least one switch contact and the switch terminals are provided on the switch mount such that when the switch mount is abutted against the further component, the further component and the switch mount define a volume such that the at least one switch contact and the switch terminals are enclosed in the volume and the switch terminals are connected to electric circuit terminals of the electric circuit.

23. A component assembly as defined in claim 22 in which the further component and switch subassembly are capable of electrically cooperating.

24. A component assembly comprising a switch subassembly and a further component, the switch subassembly including a switch mount, at least one switch contact for providing a switching function and switch terminals for electrically connecting the switch subassembly to an electric circuit of the further component, in which the at least one switch contact is provided on the switch mount such that when the switch mount is abutted against the further component the further component and the switch mount define a volume such that the at least one switch contact is enclosed in the volume and the further component and the switch assembly are capable of electrically cooperating.

25. A component assembly as defined in claim 24 in which the electric circuit includes first and second electric circuit terminals and the electric circuit proximal to the first and second electric circuit terminals is molded into the further component such that the first and second terminals project into the seal housing.

26. A component assembly as defined in claim 24 in which the further component is a door latch.

27. A component assembly as defined in claim 24 in which the further component is an actuator.
